(19) United States
(12) Patent Application Publication
(10) Pub. No.: US 2006/0184584 A1
(43) Pub. Date: Aug. 17, 2006

(54) Contact merge auto-suggest

(75) Inventors: Melissa W. Dunn, Woodinville, WA (US); Patanjali S. Venkatacharya, Seattle, WA (US); Stephen J. Mooney, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/056,611

(22) Filed: Feb. 11, 2005

(51) Int. Cl. G06F 17/30; G06F 12/00

(52) U.S. Cl. 707/200; 707/3

(57) ABSTRACT

Aspects of the present invention identify duplicate entries across multiple sources of information, such as databases. Further aspects of the invention relate to auto-suggesting entries as duplicates. Embodiments of the invention relate to an algorithm constructed to match or discard duplicates based upon information relating to at least two social identities in one store. Further embodiments of the invention relate to an algorithm constructed to match or discard duplicate entries based upon a legal and/or digital identity. This can be in conjunction with information relating to social identity.

### FIELD OF THE INVENTION

The present invention relates to the field of computer database systems. More particularly, aspects of the invention identify duplicate entries across multiple databases. Further aspects of the invention relate to auto-suggesting database entries as duplicates.

### DESCRIPTION OF RELATED ART

Computer devices are increasingly being used to store contact data. It is not uncommon for a user to store contact data in devices and locations such as mobile phones, personal digital assistants (PDAs), laptop computers and servers connected to the Internet. Synchronization applications have been developed to help users synchronize contact data stored in different locations. For example, after updating a phone number stored in a mobile telephone, a particular synchronization application may be used to synchronize the updated phone number with contact data stored in an application such as Microsoft® Outlook®.

There are several drawbacks associated with the prior art systems and methods for synchronizing contact data. Each device typically requires a unique synchronization application in order to synchronize data with another device and location. A mobile telephone might require a first synchronization application to synchronize data with Microsoft® Outlook®, a second synchronization application to synchronize data with a PDA and may be incapable of synchronizing data with a server connected to the Internet. As a result, users are typically forced to implement inconvenient and ad hoc procedures for updating contact information stored in different devices and locations. These procedures can be burdensome and frequently result in the synchronization of less than all of a user's contact data. Furthermore, such burdensome synchronization may result in the importation of duplicate entries, or in the alternative the deletion of different entries because the synchronization program erroneously marks different entries as duplicates.

Traditionally, electronic contact databases include information relating to a person's social identity. In this context, social identity generally includes information usually exchanged in social and business settings to permit the subsequent determination of the physical location of the individual. Social identity is usually stored in the form of a name, address, phone number, and email address. For example, Microsoft® Outlook® contains an electronic database having informational fields relating to personal contact information as described above and may further include more business specific information such as an individual's office location and possibly their assistant's information.

Users may add or update information manually, from received electronic mail messages, or exchange virtual business cards and other means. A problem, however, arises when different sources of contact data comprise differing informational fields. For example, one source may include a person's phone number and physical address, while another entry includes the person's email address and the phone number. Alternatively, one entry may have an individual's work electronic mail address and another entry of the same person includes their personal electronic mail address. This results in a plurality of entries each containing different, or overlapping informational fields for a single individual or entity.

Currently, databases may recognize such entry as duplicates based solely upon the individual's or entity's name. For example, searching for “John Smith” in an exemplary database will reveal any duplicates. A user may then decide to delete the duplicate; however, this may lead to loss of certain informational fields not present in the chosen entry. Slight variations in the assigned names further exacerbates the presence of duplicate entries. For example, an entry for the individual “John Smith” might already exist within a given database, however, upon the receipt of a virtual business card, for example, providing the information for “John Q. Smith”, the database may erroneous import the information as a new entry. Conversely, an algorithm in the prior art may assume, given the close resemblance of the name, that the two individuals are identical in cases where they are not. The need to query additional information before determining whether to suggest an entry is a duplicate is readily seen when individuals go by multiple names, or change names, for example, upon marriage or divorce. In such cases, entries listed under different names have identical or overlapping information, yet would not be marked as duplicates.

It goes from the foregoing, that there exists a need in the art for devices and methods to auto-suggest entries as duplicates in a database utilizing a broader criterion than those present in the prior art. There further exists a need for devices and methods that may identify duplicate entries across different databases, which may be auto-suggested as duplicates and merges the combined information into a single or predetermined number of entries within a single database. There further exists a need to determine which information to import if data from differing databases are in disagreement.

### BRIEF SUMMARY OF THE INVENTION

Aspects of the present invention overcome one or more problems and limitations of the prior art by providing devices and methods for auto-suggesting duplications in a database or a plurality of databases having contact information. As used herein, the term contact information can comprise any information relating to identifying a person, place, or thing. Contact information can include, for example, specific information such as an address (email or physical), a name, both legal and assumed, for example, names adopted for use in on-line chat rooms or memberships. Conversely, contact information can include abstract information, such business related access numbers, credit card information, or health related statistics. Aspects of the invention utilize algorithms for determining the likelihood of duplicate entries and a platform for reviewing said duplications.

Embodiments of the invention relate to an algorithm constructed to match or discard duplicates based upon information relating to at least two social identities in one store. Further embodiments of the invention relate to an algorithm constructed to match or discard duplicate entries based upon at least one legal and/or digital identity. This can be in conjunction with information relating to social identity. Legal identity generally refers to an identity provided by a government agency or an individual or entity that creates legal rights and/or obligations. Examples of legal identity include, for example, a driver's license number, credit card number, social security number, vehicle registration number, or the like. Information relating to an individual or entity's digital identity is a value obtained through a technological infrastructure, such as a SmartCard, or digital certificate.

### BRIEF DESCRIPTION OF THE DRAWINGS

The present invention is illustrated by way of example and not limited in the accompanying figures in which like reference numerals indicate similar elements and in which:

FIG. 1 illustrates an exemplary distributed computing system operating environment;

FIG. 2 illustrates a system for synchronizing data stored in a plurality of stores in accordance with an embodiment of the invention.

FIG. 3 illustrates an exemplary interface searching a plurality of stores having a plurality of social identities.

FIG. 4 illustrates the use of an exemplary interface having an algorithm that incorporates digital identity in a medical billing scenario.

### DETAILED DESCRIPTION

Exemplary Operating Environment

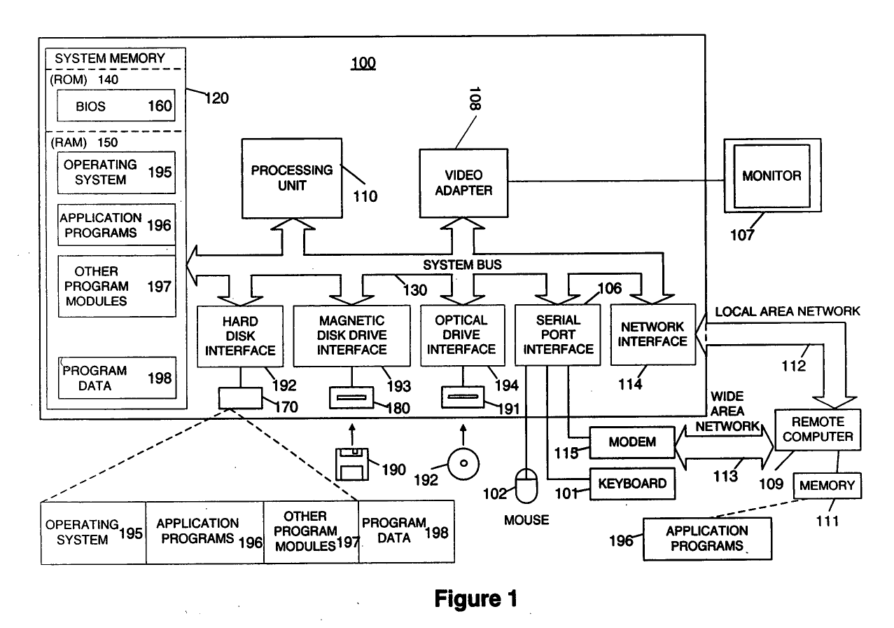

FIG. 1 is a functional block diagram of an example of a conventional general purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

Description of Illustrative Embodiments

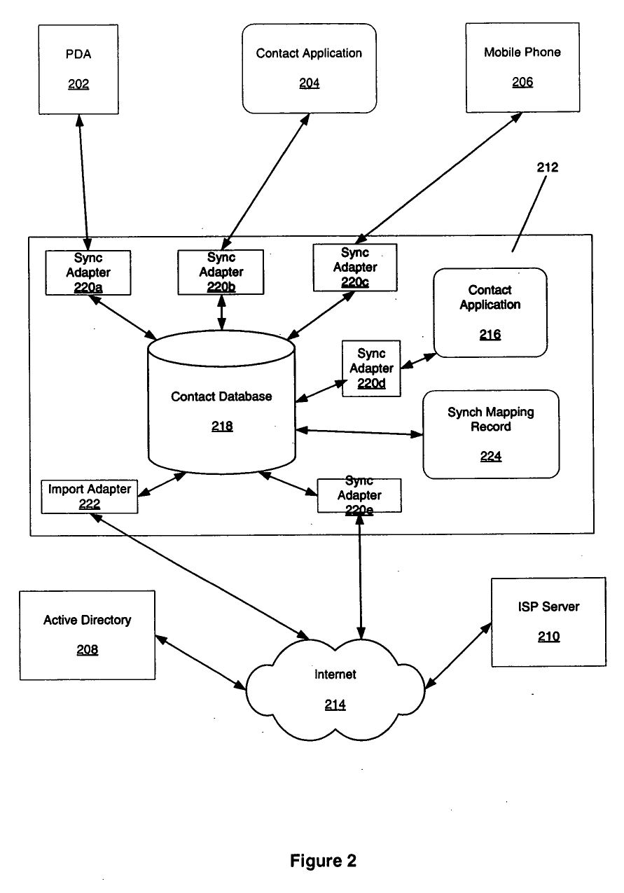

FIG. 2 illustrates a system 200 for synchronizing data stored in a plurality of stores in accordance with an embodiment of the invention. As used herein, a store may be in the form of a device or a file that may be accessed by an application. System 200 includes remote stores implemented with a personal digital assistant 202, a contact application 204, a mobile phone 206, Active Directory 208 and Internet service provider server 210. Remote stores 202, 204 and 206 may be connected directly to a computer device 212. The connections may be via one or more docking cradles, USB cables, infrared link or any other conventional mechanism used to connect a device to a computer device. Remote stores 208 and 210 may be connected to computer device 212 via the Internet 214. Computer device 212 may include one or more internal stores, such as contact application 216. In one embodiment, contact application 216 is implemented with Microsoft® Outlook®. One skilled in the art will appreciate that the aspects of the invention are not limited to the stores and data connections shown in FIG. 2.

Computer device 212 includes a contact database 218 for storing contact information. Contact information may include names, addresses, phone numbers, email addresses, instant messenger identifications, etc. In alternative embodiments of the invention, contact database 218 may also store other data, such as digital certificates, passwords, playlists, data files or any other data that a user wishes to synchronize with a store. Moreover, the function of the single database 218 may be performed with two or more databases. For example, a first database may store contact data and a second database may store playlists.

A plurality of synchronization adapters 220a-220e are used to synchronize data stored in contact database 218 and stores 202, 204, 206, 210 and 216. One skilled in the art will appreciate that structure of any particular synchronization adapter may be a function of the type of store and an application programming interface (API) that is used to access data stored in contact database 218. One or more stores may be configured to not allow a user to manage data stored in that store. Active Directory 208, for example, allows users to read data, but not to write data. Active Directory 208 may be connected to computer device 212 via an important adapter 222. Important adapter 222 is used to transfer data from Active Directory 208 to contact database 218.

A synchronization mapping record 224 may include rules, constraints or other information that governs the synchronization of data. For example, if mobile phone 206 only allows a user to store two phone numbers per name, a constraint in synchronization mapping record 224 may prevent more than two phone numbers per name from attempting to be synchronized with the data stored in mobile phone 206. FIG. 2 illustrates one embodiment of the present invention.

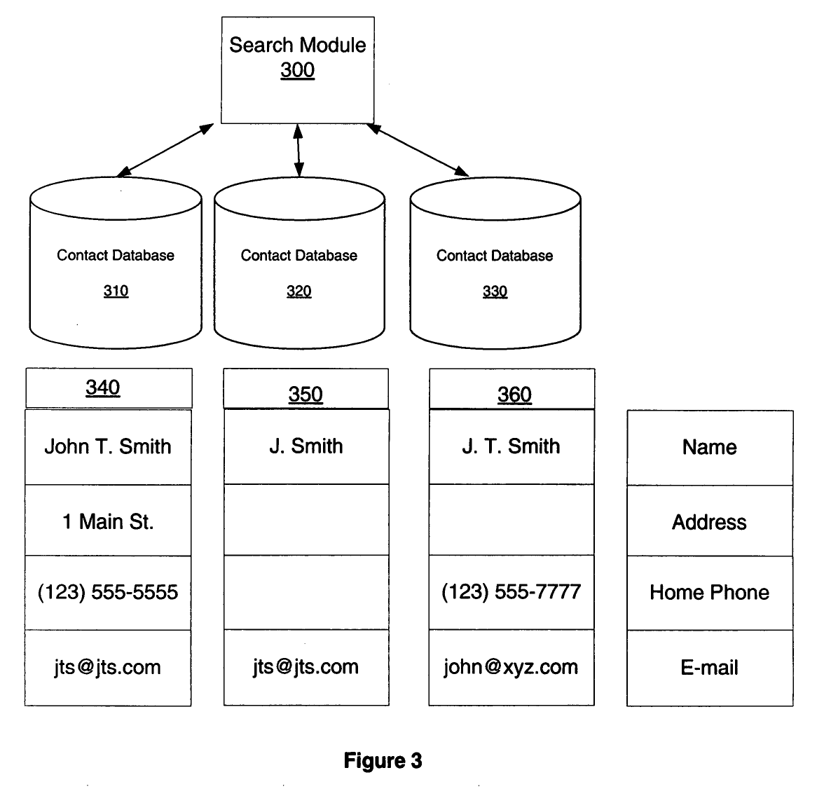

FIG. 3 illustrates an exemplary configuration for searching contact records having a plurality of social identities, wherein at least two social identities present in at least one contact record are queried. In the exemplary embodiment, a search module 300 may search multiple information sources, such as contact databases, 310, 320, 330. Search module 300 may utilize one or more APIs for communicating with contact databases 310, 320, 330 and may utilize a set of rules for searching and making comparisons. Contact databases may be, for example, within the same or different programs on the computer or LAN, a third party source, such as the importation of a virtual business card, or web-based. Indeed, any organized collection of related information is considered a database as contemplated by the invention.

Databases 310, 320, 330 include information fields comprising data relating to a contact name, a physical address, a home phone number, a work phone number, and an electronic mail address. However, additional informational fields are contemplated, as previously discussed. In the exemplary embodiment, the search module 300 sends a query to databases 310, 320, 330 regarding “John T. Smith” producing results 340, 350, 360, respectively. For purposes of this exemplary embodiment, results 340 and 350 concern the same individual and are thus considered duplicates, whereas result 360 concerns a different individual. At this juncture, traditional interfaces relying solely on the social identity of the individual's name are more likely to associate result 340 identified by the name “John T. Smith” and result 360 having the name “J. T. Smith” to be duplicates, and therefore may erroneously delete one of or merge results 340 and 360.

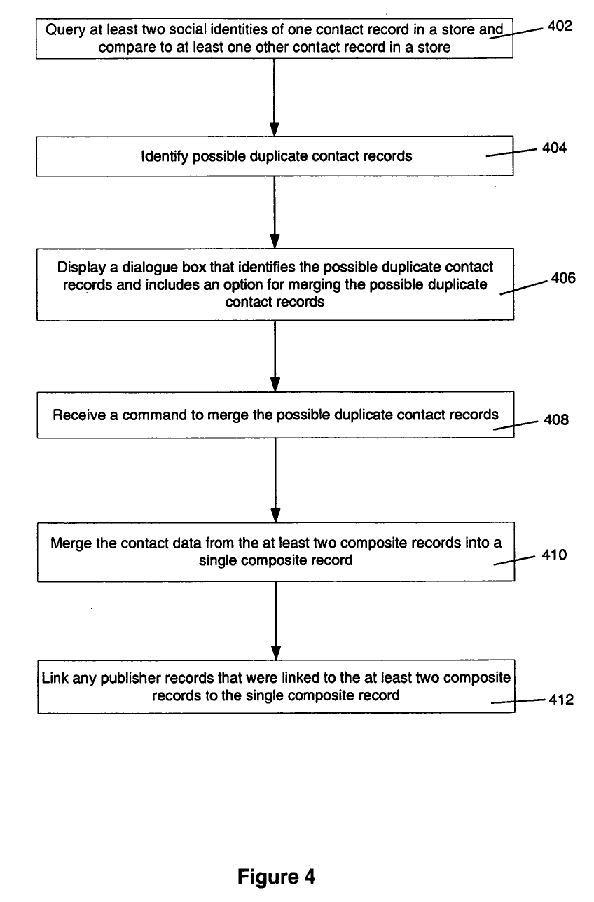

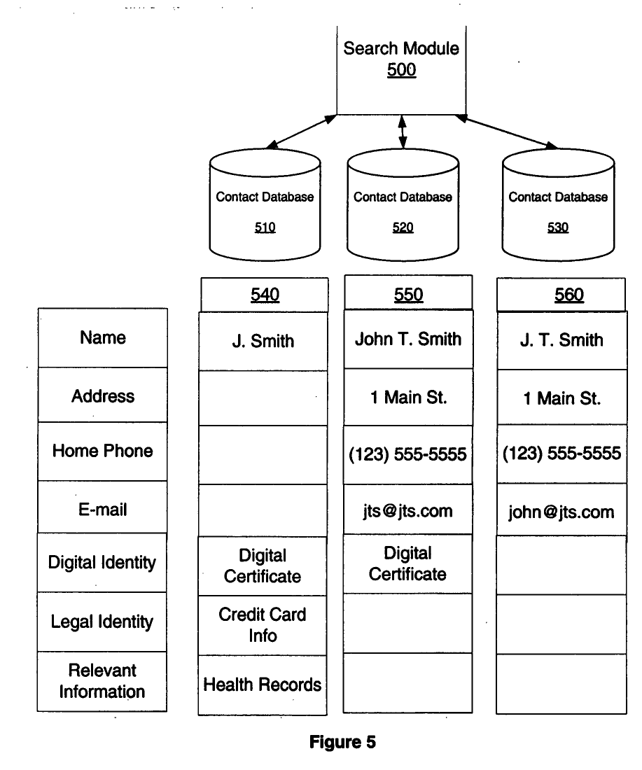

In accordance with an embodiment of the present invention, contacts are considered possible duplicates when at least two social identities match. For example, results 340 and 350 may be considered duplicates because the addresses and electronic mail information fields match. Embodiments of the present invention include algorithms of variable degrees, where different informational fields may be given weight. For example, in the exemplary embodiment, the algorithm considers the physical address more indicative of a duplicate than the phone number. Reasons for constructing such an algorithm include, for example, because database 340 has a work related phone number, whereas database 360 may include a cellular or home phone number. Moreover, it is common for individuals to change cellular phone numbers quite frequently. In other embodiments, however, the algorithm may consider a phone number more indicative of a duplicate. Upon determination that results 340 and 350 are duplicates, an auto-suggest feature may be initiated as illustrated in FIG. 4.

FIG. 4 illustrates a computer-implemented method of merging duplicate contact records, in accordance with an embodiment of the invention. First, in step 402, at least two social identities of one contact record in a store are queried and compared to at least one other contact record in a store. The contact records may include various combinations of publisher records and composite records. Social identity claims may include phone numbers, addresses or other information that is likely to uniquely identify a contact. The example given above shows that names alone are not good identity claims because it is common to have minor variations in names.

In step 404 possible duplicate contact records are identified. Possible duplicate contact records may correspond to contact records having the same identity claims. In step 406 a dialog box is displayed that identifies the possible duplicate contact records and includes an option for merging the possible duplicate contact records. In step 408 a command to merge the possible duplicate records is received. Any number of applications may allow explicit control over autosuggest to the user or implicitly execute an auto-suggest feature by invoking an autosuggest API. For example, a handler associated with the contact file extension may invoke the auto-suggest API when a user attempts to save the information. These embodiments may further allow the user to merge the information provided by the multiple databases. In other embodiments, a shell UI may comprise a feature that invokes an auto-suggest feature for each contact in the store, allowing the user to individually confirm or reject each suspected duplicate.

In steps 410, the contact data from the at least two composite records is merged into a single composite record. For example, if one composite record corresponds to a contact identified as John Smith and a second composite record corresponds to a contact identified as Jonathan Smith, the contact data from both records would be merged into a single composite record that identify the contact with a single name. Finally, in step 412, the publisher records that were linked to the original composite records are linked to the single composite record. Re-linking the publisher records to the composite record ensures that contact data will be synchronized appropriately.

In yet other embodiments of the present invention, digital identity may be utilized in conjunction with, or in place of, social and/or legal identity to identify duplicates. An algorithm that considers digital identities when matching or discarding entries advantageously creates additional security to ensure a proper determination is made. Furthermore, it allows for the proper pairing of entries when little other information is available. For example, in the exemplary embodiment of FIG. 5, an algorithm considers the presence of a digital identity more indicative of a duplicate than the name or other social identification, or lack thereof. Having such an algorithm is invaluable for uses handling sensitive information, such as medical or financial information.

For example, FIG. 5 illustrates the use of an exemplary search module 500 having an algorithm that incorporates digital identity in a medical billing scenario. Search module 500 queries databases 510, 520, and 530 for “John T. Smith”, obtaining results 540, 550, and 560, respectively. Each result has different degrees of information relating to social, legal, and digital identification. For example, entry 540 fails to provide any social identification besides “J. Smith”, whereas both entries 550 and 560 provide at least two initials of the individuals name, a physical address, and an electronic mail address (entry 550 additionally supplies a phone number). Entry 540, however, does provide digital identity information, for example, a unique value or certificate. The presence of the digital certificate may permit the entry to be considered a duplicate. Additionally, an algorithm in accordance with the present invention could be constructed so that the presence of a digital certificate will mark an entry as a duplicate, even if other information present in the entry is incorrect.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computer-implemented method for auto-suggesting multiple contact entries as duplicates, the method comprising the steps of:
(a) receiving a contact record from a store;
(b) receiving a second contact record from a store;
(c) querying at least two social identities within the first contact record and the second contact record to identify possible duplicates; and
(d) upon the determination the first set and second contact record are possible duplicates, auto-suggesting to a user the data sets are duplicates.

2. The computer-implemented method of claim 1, wherein the first contact record and the second contract record are received from different stores.

3. The computer-implemented method of claim 1, wherein at least one social identity is selected from the group consisting of names, nicknames, physical addresses, telephone numbers, electronic mail addresses, membership information, and combinations thereof.

4. The computer-implemented method of claim 1, further including:
(e) prompting the user to merge the first contact record and the second contact record into a single contact record.

5. The computer-implemented method of claim 4, further including:
(f) upon the event of conflicting information within the first contact record and the second contact record, prompting the user to determine which information is to be merged into the single contact record.

6. The computer-implemented method of claim 1, wherein (c) further comprises querying at least one legal identity within the first contact record and second contact record to determine if the records are possible duplicates.

7. The computer-implemented method of claim 6, wherein at least one legal identity comprises government-issued credentials

8. The computer-implemented method of claim 7, wherein the legal identity is selected from the group consisting of a driver's license number, a vehicle registration number, and a social security number.

9. The computer-implemented method of claim 6, wherein at least one legal identity comprises financial information.

10. The computer-implemented method of claim 1, further including:
(e) querying at least one digital identity within the first contact record and the second contact record to determine if the records are duplicates.

11. The computer-implemented method of claim 6, further including:
(e) querying at least one digital identity within the first contact record and the second contact record to determine if the records are duplicates.

12. The computer-implemented method of claim 10, further including:
(f) auto-suggesting to a user that the first contact record and the second contact record are duplicates upon the matching of at least one digital identity within the first and second contact records.

13. The computer-implemented method of claim 11, further including:
(f) auto-suggesting to a user that the first contact record and the second contact record are duplicates upon the matching of at least one digital identity within the first and second contact records.

14. A computer-implemented method for auto-suggesting multiple contact entries as duplicates, the method comprising the steps of:
(a) receiving a first contact record from a store;
(b) receiving a second contact record from a store;
(c) querying at least one legal identity within the first and second contact records to determine if the sets are duplicates; and
(d) upon the determination the first set and second contact record are possible duplicates, auto-suggesting to a user the data sets are duplicates.

15. The computer-implemented method of claim 14, wherein at least one legal identity comprises government-issued credentials

16. The computer-implemented method of claim 15, wherein the legal identity is selected from the group consisting of a driver's license number, a vehicle registration number, and a social security number.

17. The computer-implemented method of claim 14, wherein at least one legal identity comprises financial information.

18. The computer-implemented method of claim 14, wherein (c) further includes querying at least one digital identity within the first and second sets of data to determine if the contact records are possible duplicates.

19. The computer-implemented method of claim 13, wherein (c) further includes querying at least one social identity within the first and second sets of data to determine if the sets are duplicates.

20. The computer-implemented method of claim 14, further including:
(f) auto-suggesting the first and second sets of data as duplicates upon the matching of at least one digital identity in the first and second contact records, regardless of the social identities and legal identities in the contact records.
